(19) United States
(12) Patent Application Publication
(10) Pub. No.: US 2021/0397635 A1
(43) Pub. Date: Dec. 23, 2021

(54) INFORMATION PROCESSING DEVICE, INFORMATION PROCESSING SYSTEM, AND COMPUTER-READABLE RECORDING MEDIUM STORING INFORMATION PROCESSING PROGRAM

(71) Applicant: FUJITSU LIMITED, Kawasaki-shi (JP)

(72) Inventors: Naohiro Heya, Kawasaki (JP); Minoru Nakamura, Kawasaki (JP)

(73) Assignee: FUJITSU LIMITED, Kawasaki-shi (JP)

(21) Appl. No.: 17/462,051

(22) Filed: Aug. 31, 2021

Related U.S. Application Data
(63) Continuation of application No. PCT/JP2019/011610, filed on Mar. 19, 2019.

(51) Int. Cl. G06F 16/34; G06F 9/48; G06F 9/455; G06F 16/335

(52) U.S. Cl. CPC G06F 16/34; G06F 16/335; G06F 9/45508; G06F 9/4856

(57) ABSTRACT

An information processing device includes: a memory; and a processor coupled to the memory and configured to: obtain an identifier of a process being executed in the information processing device; identify a data processing tool corresponding to the process on the basis of the identifier of the process;

analyze descriptive contents of a running script of the identified data processing tool to identify an input data name and an output data name on the basis of an analysis result; and generate data lineage related to the script on the basis of the input data name and the identified output data name.

### CROSS-REFERENCE TO RELATED APPLICATION

This application is a continuation application of International Application PCT/JP2019/011610 filed on Mar. 19, 2019 and designated the U.S., the entire contents of which are incorporated herein by reference.

### FIELD

The embodiment discussed herein is related to an information processing device, an information processing system, and an information processing program.

### BACKGROUND

Conventionally, there has been a technique of generating data lineage recording, as an attribute of a file, a source and a distributive channel of the file for the file generated in the process of data analysis/processing. According to the data lineage, it becomes possible to visualize a dependence relationship between data, and to grasp what kind of analysis/processing has been performed on which data, for example.

Japanese Laid-open Patent Publication No, 2013-012225, International Publication Pamphlet No. WO 2012/001763, and International Publication Pamphlet No, WO 2013/042218 are disclosed as related art.

### SUMMARY

According to an aspect of the embodiments, an information processing device includes: a memory; and a processor coupled to the memory and configured to: obtain an identifier of a process being executed in the information processing device; identify a data processing tool corresponding to the process on the basis of the identifier of the process; analyze descriptive contents of a running script of the identified data processing tool to identify an input data name and an output data name on the basis of an analysis result; and generate data lineage related to the script on the basis of the input data name and the identified output data name.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing device 101 according to an embodiment;

FIG. 2 is an explanatory diagram illustrating an exemplary system configuration of an information processing system 200;

FIG. 3 is a block diagram illustrating an exemplary hardware configuration of a client device 201;

FIG. 4 is a block diagram illustrating an exemplary functional configuration of the client device 201;

FIG. 5 is an explanatory diagram illustrating a specific example of dictionary information;

FIG. 6 is an explanatory diagram illustrating exemplary descriptive contents of an analysis script;

FIG. 7 is an explanatory diagram (No. 1) illustrating a specific example of data lineage;

FIG. 8 is an explanatory diagram (No. 1) illustrating an exemplary screenshot of a window;

FIG. 9 is an explanatory diagram (No. 2) illustrating a specific example of data lineage;

FIG. 10 is an explanatory diagram (No. 2) illustrating an exemplary screenshot of a window;

FIG. 11 is an explanatory diagram illustrating a first example of the information processing system 200;

FIG. 12 is a flowchart (No. 1) illustrating an example of a first data lineage generation processing procedure of the client device 201;

FIG. 13 is a flowchart (No. 2) illustrating an example of the first data lineage generation processing procedure of the client device 201;

FIG. 14 is an explanatory diagram illustrating a second example of the information processing system 200;

FIG. 15 is a flowchart (No. 1) illustrating an example of a second data lineage generation processing procedure of the client device 201; and

FIG. 16 is a flowchart (No. 2) illustrating an example of the second data lineage generation processing procedure of the client device 201.

### DESCRIPTION OF EMBODIMENTS

Examples of prior art include a technique of obtaining an HTML document from a business server on the basis of specified port information, obtaining a TITLE element indicating a title from the obtained HTML document, and identifying the obtained TITLE element as an application name of process identification information associated with standby port information in the collected process list that matches with the specified port information. Furthermore, there has been a technique for displaying a history of file operations in a tree structure.

Furthermore, there has been a technique of storing, in a case where it is detected that a file stored in a file server is to be deleted, the file in a storage area as a backup file, and storing, in a metadata repository, information indicating the storage location of the file in the file server and information indicating the storage location of the backup file in the storage area in association with each other.

However, according to the conventional techniques, data lineage may not be generated depending on a data processing tool. For example, while data lineage may be automatically generated at the time of data analysis in the case of an analysis tool supporting specific metadata management software, it is not possible to generate data lineage unless the analysis tool itself is modified in the case of not supporting the specific metadata management software.

In one aspect, the present embodiment generates data lineage without modifying a data processing tool.

Hereinafter, an embodiment of an information processing device, an information processing system, and an information processing program will be described in detail with reference to the accompanying drawings.

### Embodiment

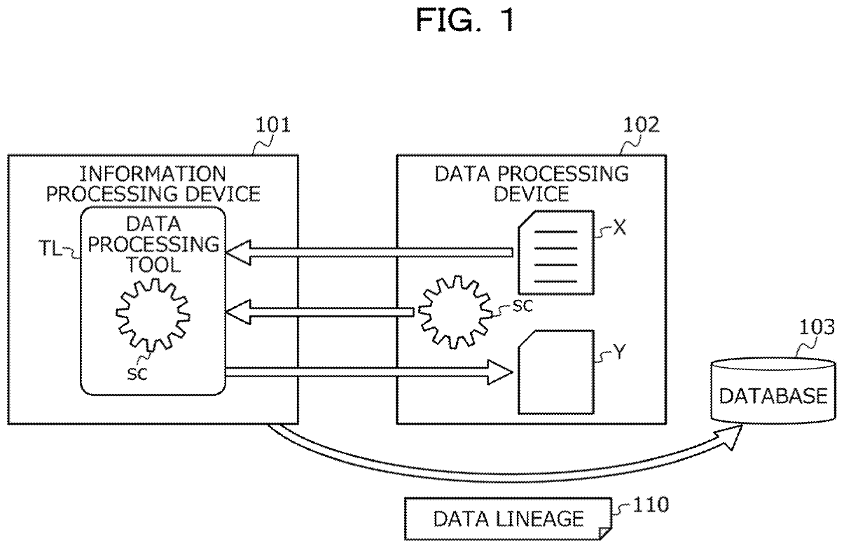

FIG. 1 is an explanatory diagram illustrating an example of an information processing device 101 according to an embodiment. In FIG. 1, the information processing device 101 is a computer that generates data lineage. For example, the information processing device 101 is a personal computer (PC) to be used by a user. A data processing device 102 is a computer that processes data. For example, the data processing device 102 is a server. A database 103 is a storage device that stores data lineage.

The data processing device 102 reads and writes data in response to a request from the information processing device 101. More specifically, for example, the information processing device 101 accesses the data processing device 102, reads a file, performs data analysis using an analysis tool, and writes the file obtained through the data analysis.

Data lineage is historical information indicating how the data has been generated. According to the data lineage, it becomes possible to visualize a dependence relationship between data, and to grasp what kind of analysis/processing has been performed on which data and which data has been generated, thereby promoting data utilization.

For example, when certain processing is executed on a trial basis to obtain a favorable result, it may be desirable to execute the same processing again. However, it is difficult to reproduce the same processing without knowing which data has been input and which analysis tool has been used to obtain the result. In such a case, if there is data lineage, it is possible to grasp what kind of processing is performed on which data and which data has been generated, whereby the same processing may be easily reproduced.

Here, with an analysis tool supporting a data format and protocol of specific metadata management software, it is conceivable to impart a function that the analysis tool automatically generates data lineage at the time of data analysis and registers it in the metadata management software. However, it is not possible to register data lineage without using an analysis tool supporting specific metadata management software,

Furthermore, if the analysis tool desired to be used does not support the specific metadata management software, it is conceivable to modify the analysis tool to be capable of registering data lineage. However, the analysis tool needs to be modified so that data lineage can be registered, which causes a designer to spend time and effort.

Furthermore, a file system is capable of identifying which file has been read/written. Accordingly, it is conceivable to generate data lineage by providing the file system with a function of registering information in which a read file and a written file are associated with each other. However, it is not possible to generate information that identifies which analysis script of which analysis tool has generated the file.

Therefore, no matter what analysis tool is used for work, a system capable of automatically generating data lineage in which the script of the analysis tool and input/output data are associated with each other is desired. Furthermore, there is a demand for generating data lineage by running an analysis tool on the client side and identifying the files used for input and output.

In view of the above, in the present embodiment, the information processing device 101 that automatically generates, without modifying a data processing tool, data lineage in which a script and input/output data are associated with each other will be described. Hereinafter, exemplary processing of the information processing device 101 will be described.

(1) The information processing device 101 obtains an identifier of the process being executed by the device itself, Specifically, for example, the information processing device 101 obtains an identifier of the process being executed by the device itself on the basis of information transmitted and received between the device itself and the data processing device 102 using a predetermined protocol. The predetermined protocol is a communication protocol to be used at the time of exchanging information between the information processing device 101 and the data processing device 102.

For example, a web-based distributed authoring and versioning (WebDAV) protocol may be used as the protocol. The WebDAV protocol is a type of a file sharing protocol obtained by extending a hypertext transfer protocol (HTTP).

The identifier of the process is information that uniquely identifies the process being executed by the information processing device 101, which is, for example, a process ID (PID) given by an operating system (OS), More specifically, for example, the information processing device 101 may obtain the process ID from a port number via which information is transmitted to and received from the data processing device 102.

Note that the information transmitted and received between the information processing device 101 and the data processing device 102 using a predetermined protocol includes, for example, various kinds of information (data body, data name, etc.) associated with a data processing tool, a script, input data, and output data. However, it is not possible to identify which data corresponds to which script of hich data processing tool by simply monitoring the protocol.

(2) The information processing device 101 identifies, on the basis of the obtained identifier of the process, a data processing tool corresponding to the process. Here, the data processing tool is software that processes data. For example, the data processing tool is an analysis tool that analyzes input data.

The data processing tool exists as a process in the OS at runtime. Accordingly, the information processing device 101 makes an inquiry to the OS using a task manager or the like, for example, thereby obtaining a software name (e.g., tool name) corresponding to the process ID. As a result, it becomes possible to identify the data processing tool from the software name corresponding to the process ID.

In the example of FIG. 1, a case where a data processing tool TL being executed by the infomiation processing device 101 is identified from the process ID is assumed.

(3) The information processing device 101 analyzes the descriptive contents of the running script of the identified data processing tool, and identifies the input data name and the output data name on the basis of the analysis result. Here, the script is a program that describes what kind of data is processed and how.

The data processing tool changes the process according to the contents of the script, and executes the process using the script. The input data name is a name of data (input data) input to the script of the data processing tool. The output data name is a name of data (output data) obtained as a result of processing the input data using the script of the data processing tool.

Specifically, for example, the information processing device 101 reads a running script of the identified data processing tool. The storage location of the script may be identified from information indicating the storage location of the script for each script of the data processing tool, for example. Note that some of the scripts of the data processing tool are stored in the information processing device 101 in advance, and some are obtained from the data processing device 102 at runtime to be stored in the information processing device 101.

Next, the information processing device 101 analyzes the descriptive contents of the read script. Then, the information processing device 101 identifies the input data name and the output data name described in the script on the basis of the analysis result. For example, the information processing device 101 analyzes the contents (source code) of the script to identify the name of the input data and the name of the data obtained as a result of processing the data.

In the example of FIG. 1, a case where an input data name X and an output data name Y are identified on the basis of the result of analyzing the descriptive contents of a running script sc of the data processing tool TL is assumed.

(4) The information processing device 101 generates data lineage related to the running script of the identified data processing tool on the basis of the identified input data name and the output data name. Specifically, for example, the information processing device 101 generates data lineage indicating the identified input data name and output data name in association with information regarding the running script of the data processing tool.

The information regarding the script is, for example, a script name. The script name may be identified from, for example, the file name of the script (file currently open) running in the information processing device 101. Furthermore, the information regarding the script may also include a tool name of the data processing tool.

In the example of FIG. 1, data lineage 110 indicating the input data name X and the output data name Y is generated in association with the information regarding the running script sc of the data processing tool TL. The generated data lineage 110 is registered in the database 103, for example.

As described above, according to the information processing device 101, it becomes possible to automatically generate data lineage in which a script and input/output data are associated with each other without modifying a data processing tool. In the example of FIG. 1, even in a case where the data processing tool TL does not support specific metadata management software, it is possible to generate the data lineage 110 in which the script sc, the input data X, and the output data Y are associated with each other by analyzing the contents of the running script sc of the data processing tool TL.

As a result, it becomes possible to grasp what kind of analysis (script sc) has been performed on which data (input data X) and which data (output data Y) has been generated, thereby promoting data utilization. For example, as an advantage with respect to data, it becomes possible to grasp what the data and learning model used/generated by machine learning are used for. Furthermore, as an advantage with respect to a data processing tool, it becomes possible to visualize changes in SQL statements due to a version upgrade of a database and what kind of conversion is carried out, thereby making it easier to perform debug.

### Exemplary System Configuration of Information Processing System 200

Next, an exemplary system configuration of the information processing system 200 according to the embodiment will be described. Here, an exemplary case where the information processing device 101 illustrated in FIG. 1 is applied to the client device 201 will be described. The information processing system 200 is applied to, for example, a computer system for performing data analysis using data and tools stored in an office.

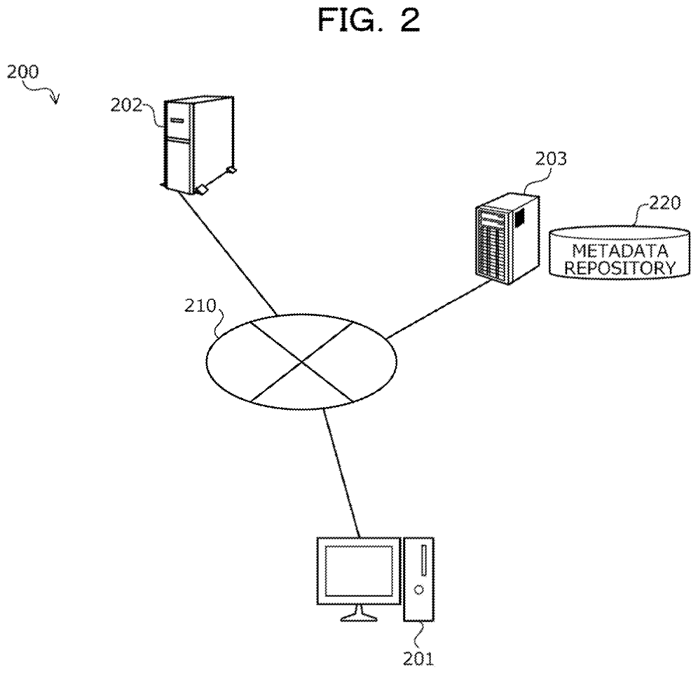

FIG. 2 is an explanatory diagram illustrating an exemplary system configuration of the information processing system 200. In FIG. 2, the information processing system 200 includes a client device 201, a server 202, and a metadata management server 203. In the information processing system 200, the client device 201, the server 202, and the metadata management server 203 are connected via a wired or wireless network 210. The network 210 is, for example, a local area network (LAN), a wide area network (WAN), the Internet, or the like.

Here, the client device 201 is a computer to be used by a user of the information processing system 200. The user is, for example, a data scientist, a staff of a business unit, or the like. For example, the client device 201 is a PC, a tablet PC, or the like.

The server 202 reads and writes data in response to a request from the client device 201. For example, the client device 201 may access the server 202, read a file, perform data analysis using an analysis tool, and write the data obtained by the analysis. The data processing device 102 illustrated in FIG. 1 corresponds to the server 202, for example.

The metadata management server 203 has a metadata repository 220, and manages data lineage. The metadata repository 220 is a database that stores data lineage. The database 103 illustrated in FIG. 1 corresponds to the metadata repository 220, for example. The server 202 and the metadata management server 203 are constructed by, for example, an application server, a web server, a database server, and the like.

Note that, although the respective client device 201, server 202, and metadata management server 203 are constructed by separate computers here, it is not limited thereto. For example, the client device 201, the server 202, and the metadata management server 203 may be constructed by one computer.

### Exemplary Hardware Configuration of Client Device 201

Next, an exemplary hardware configuration of the client device 201 will be described.

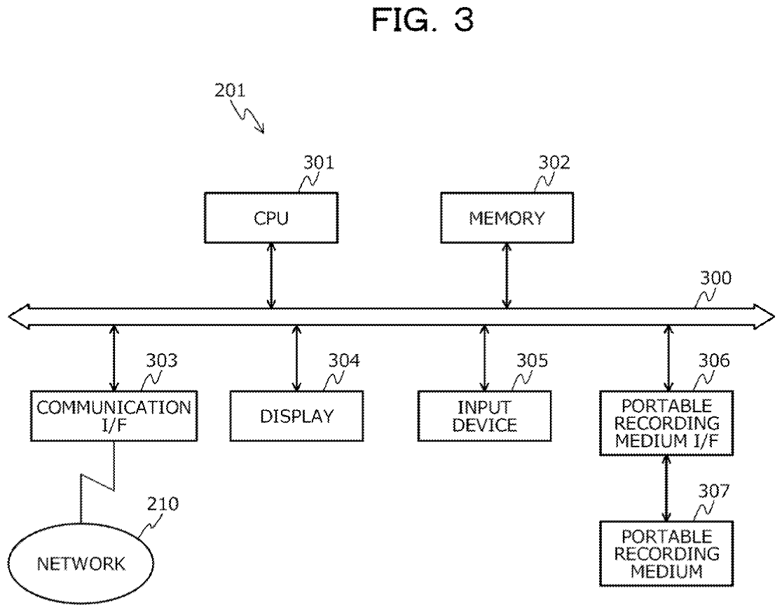

FIG. 3 is a block diagram illustrating an exemplary hardware configuration of the client device 201. In FIG. 3, the client device 201 includes a central processing unit (CPU) 301, a memory 302, a communication interface (I/F) 303, a display 304, an input device 305, and a portable recording medium I/F 306. Furthermore, the respective components are connected to each other via a bus 300.

Here, the CPU 301 performs overall control of the client device 201. The CPU 301 may have multiple cores. The memory 302 is a storage unit including a read only memory (ROM), a random access memory (RAM), a flash ROM, and the like, for example. Specifically, for example, the flash ROM and the ROM store various kinds of programs, and the RAM is used as a work area for the CPU 301. A program stored in the memory 302 is loaded into the CPU 301 to cause the CPU 301 to execute coded processing.

The communication I/F 303 is connected to the network 210 through a communication line, and is connected to an external computer (e.g., server 202, metadata management server 203) via the network 210. Then, the communication I/F 303 manages an interface between the network 210 and the inside of its own device, and controls input/output of data from an external device.

The display 304 is a display device that displays data such as a document, an image, or functional information, as well as a cursor, an icon, or a toolbox. For example, a liquid crystal display, an organic electroluminescence (EL) display, or the like may be adopted as the display 304.

The input device 305 has keys for inputting characters, numbers, various instructions, and the like, and performs data input. The input device 305 may be a keyboard, a mouse, or the like, or may be a touch-panel input pad, numeric keypad, or the like.

The portable recording medium I/F 306 controls read/write of data to be performed on the portable recording medium 307 under the control of the CPU 301. The portable recording medium 307 stores data written under the control of the portable recording medium I/F 306. Examples of the portable recording medium 307 include a compact disc (CD)-ROM, a digital versatile disk (DVD), a universal serial bus (USB) memory, or the like.

Note that the client device 201 may include a hard disk drive (HDD), a solid state drive (SSD), a scanner, a printer, and the like, in addition to the components described above. Furthermore, the server 202 and the metadata management server 203 illustrated in FIG. 2 may also be constructed by a hardware configuration similar to that of the client device 201. However, the server 202 and the metadata management server 203 do not necessarily include the display 304 and the input device 305.

### Exemplary Functional Configuration of Client Device 201

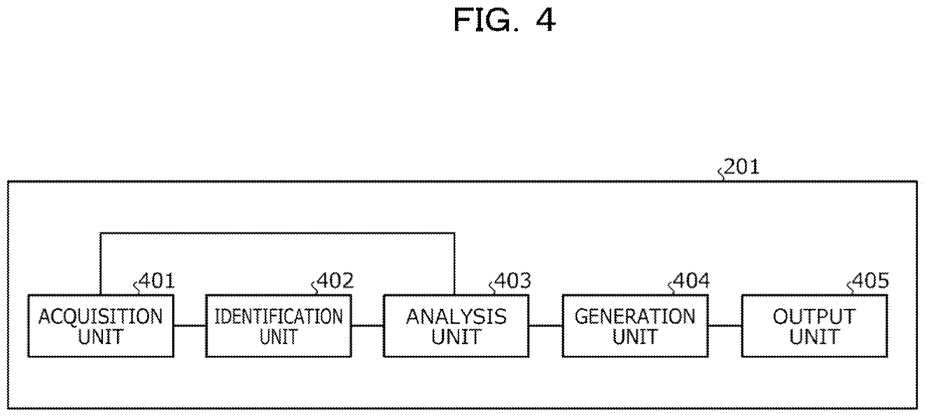

FIG. 4 is a block diagram illustrating an exemplary functional configuration of the client device 201. In FIG. 4, the client device 201 includes an acquisition unit 401, an identification unit 402, an analysis unit 403, a generation unit 404, and an output unit 405. Specifically, for example, each of the acquisition unit 401 to output unit 405 implements its function by causing the CPU 301 to execute a program stored in a storage device, such as the memory 302 and the portable recording medium 307 illustrated in FIG. 3, or by the communication I/F 303. The processing result of each functional unit is stored in the memory 302, for example.

The acquisition unit 401 obtains the identifier of the process being executed by its own device. Specifically, for example, the acquisition unit 401 obtains the identifier of the process being executed by its own device on the basis of information transmitted and received between its own device and the server 202 using a predetermined protocol. For example, a WebDAV protocol or a system call protocol may be used as the predetermined protocol.

The WebDAV protocol is a type of a file sharing protocol obtained by extending the HTTP, which allows the OS to mount a directory in the server. The system call protocol is a protocol using a system call that is a mechanism for calling OS functions, which enables a computer to be used without regard to hardware.

The information transmitted and received between the client device 201 and the server 202 includes, for example, various kinds of information associated with a data processing tool, a script, input data, and output data. For example, information associated with a script is a data body of the script (source code or binary data), a script name, and the like. Information associated with input data is a data body, a file name, and the like of an input file transmitted from the server 202 to the client device 201. Information associated with output data is a data body, a file name, and the like of output data transmitted from the client device 201 to the server 202.

For example, the WebDAV protocol is assumed to be used as a predetermined protocol. In this case, the acquisition unit 401 obtains a process ID from the port number via which information is transmitted to and received from the server 202 using a command such as netstat, for example. The process ID is an identifier given by the OS to uniquely identify the currently running process.

Note that, in a case where the WebDAV is developed by a virtual file system framework of Windows (Installable File System, Shell namespace extensions), the acquisition unit 401 may obtain the process ID using a shell extension handler, for example. In this case, it is possible to know the process ID regardless of the port number of the TCP connection.

Furthermore, the system call protocol is assumed to be used as a predetermined protocol. In this case, the acquisition unit 401 obtains a process ID of a caller of a specific system call, for example. The specific system call is, for example, a system call such as open, read, or write.

The identification unit 402 identifies, on the basis of the obtained identifier of the process, a data processing tool corresponding to the process. Here, the data processing tool is software that processes data, which is, for example, an analysis tool that analyzes data.

In the following descriptions, a data processing tool may be referred to as an “analysis tool”, and a script of the data processing tool may be referred to as an “analysis script”.

Specifically, for example, the identification unit 402 makes an inquiry to the OS using a task manager, a ps command, or the like, thereby obtaining an analysis tool name corresponding to the process ID. As a result, it becomes possible to identify the analysis tool being executed by the client device 201 from the analysis tool name corresponding to the process ID.

The analysis unit 403 identifies the input data name and the output data name on the basis of the result of analyzing the descriptive contents of the running analysis script of the identified analysis tool. Here, the analysis script is a program that describes what kind of file is processed and how. The analysis script includes, for example, one or a plurality of files.

Specifically, for example, the analysis unit 403 reads the running analysis script of the identified analysis tool. More specifically, for example, the analysis unit 403 refers to tool management information to identify an analysis script name corresponding to the identified analysis tool name.

Here, the tool management information includes information associated with one or a plurality of analysis scripts corresponding to the analysis tool. For example, the tool management information indicates a correspondence relationship between the analysis tool name of the analysis tool, the analysis script name of the analysis script of the analysis tool, and the storage location of the analysis script. The tool management information is created in advance and stored in the memory 302, for example.

Furthermore, the analysis unit 403 identifies a file name of the file currently being executed (file currently open) in its own device. Then, the analysis unit 403 identifies, among the analysis script names corresponding to the identified analysis tool name, an analysis script name that matches the identified file name as a name of the running analysis script of the identified analysis tool.

Next, the analysis unit 403 refers to the tool management information to identify the storage location of the identified analysis script. Then, the analysis unit 403 reads the analysis script from the identified storage location. As a result, even when a plurality of files is open in the client device 201, it is possible to obtain information (e.g., source code) associated with the running analysis script of the analysis tool identified by the identification unit 402.

Next, the analysis unit 403 analyzes the descriptive contents (source code) of the read analysis script. Then, the analysis unit 403 identifies an input file name and an output file name described in the analysis script on the basis of the analysis result. The input file name is a name of the input file (input data name) input to the analysis tool. The output file name is a name of the output file (output data name) obtained as a result of processing the input file with the analysis tool.

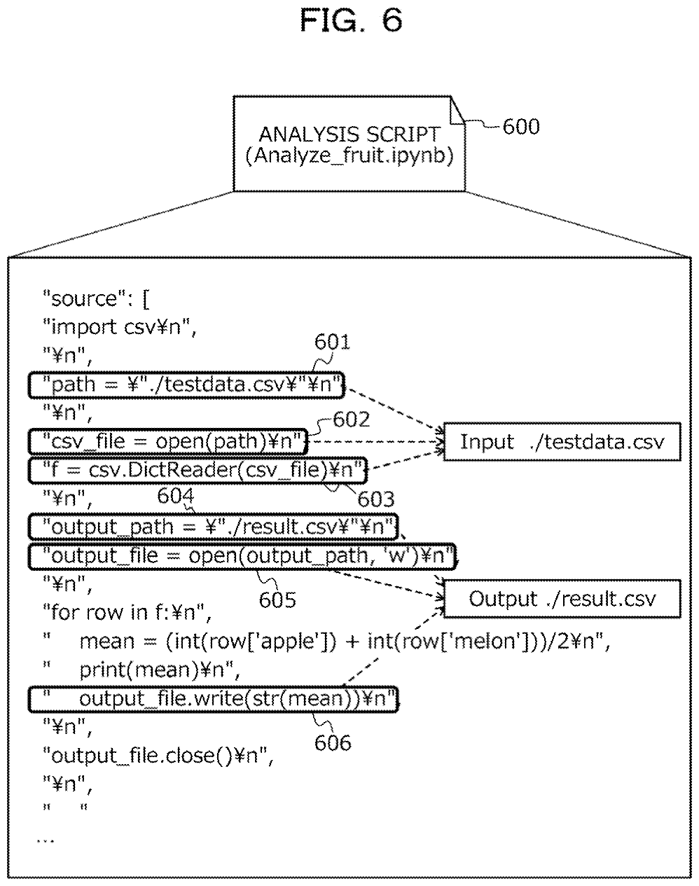

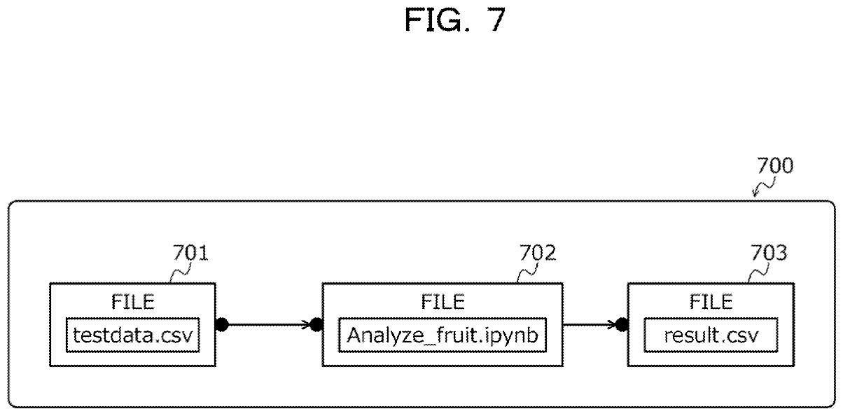

Note that an exemplary process at the time of identifying the input data name (input file name) and the output data name (output file name) from the descriptive contents of the analysis script will be described later with reference to FIGS. 6 and 7.

However, it may not be possible to analyze the descriptive contents of the analysis script. For example, in a case where the analysis tool is a closed source, the source code is not disclosed, and only binary data is distributed. In a case where the analysis script is binary data, it is not possible to analyze the analysis script to identify the input/output file name. Furthermore, also in a case where the storage location of the analysis script has failed to be identified, it is not possible to analyze the descriptive contents of the analysis script.

Here, there may be a case where the analysis tool has a window interface based on a graphical user interface (GUI). In this case, for example, the analysis script name, the input file name, and the output file name may be displayed in the window.

In view of the above, in a case where the descriptive contents of the analysis script are not analyzable, the analysis unit 403 may obtain a window handle corresponding to the identifier of the obtained process. Then, the analysis unit 403 may identify the script name, the input data name, and the output data name on the basis of the result of recognizing the information in the window identified from the obtained window handle.

Here, the window handle indicates an identifier that identifies the window displayed on the screen. The result of recognizing the information in the window is, for example, the result of recognizing the image of the window through optical character reader (OCR) processing. The OCR processing is processing of analyzing an image to identify characters and symbols. Furthermore, the result of recognizing the information in the window may be the result of obtaining and recognizing the information in the window using GetWindowText of Win32 API or the like.

Specifically, for example, the analysis unit 403 makes an inquiry to the OS on the basis of the obtained process ID, thereby obtaining a window handle corresponding to the process ID. Next, the analysis unit 403 obtains a screenshot of the GUI window identified from the obtained window handle. Then, the analysis unit 403 identifies the analysis script name, the input file name, and the output file name on the basis of the result of OCR processing and recognizing the obtained screenshot.

More specifically, for example, the analysis unit 403 identifies the character string “file” displayed in the window, and identifies a character string corresponding to the identified character string “file” as a file name. Furthermore, the analysis unit 403 identifies the character string “script” displayed in the window, and identifies a character string corresponding to the identified character string “script” as a file name. The character strings corresponding to the respective character strings “file” and “script” are identified on the basis of, for example, positions in the window.

However, it is also permissible if the analysis script name is identified from the operation of invoking the window, for example. For example, in a case where the analysis tool is “mail software”, operation of invoking “replay” is assumed to be performed by operation input made by the user. In this case, the analysis unit 403 identifies “replay” as an analysis script name.

Furthermore, in a case where a plurality of window handles is obtained, the analysis unit 403 obtains a screenshot of the window for each window identified from each of the plurality of window handles, for example. Then, the analysis unit 403 identifies various file names for each obtained screenshot on the basis of the result of OCR processing and recognizing the screenshot.

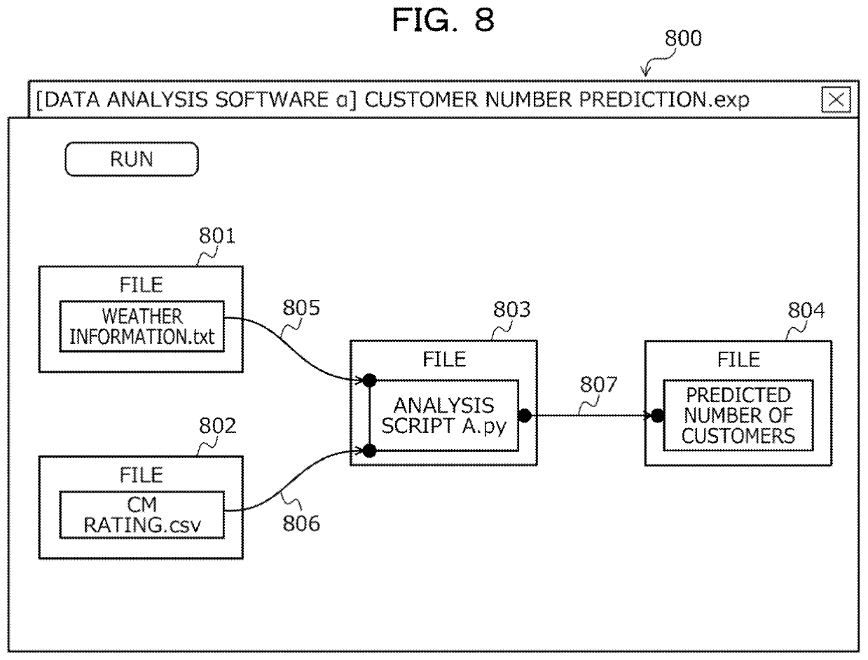

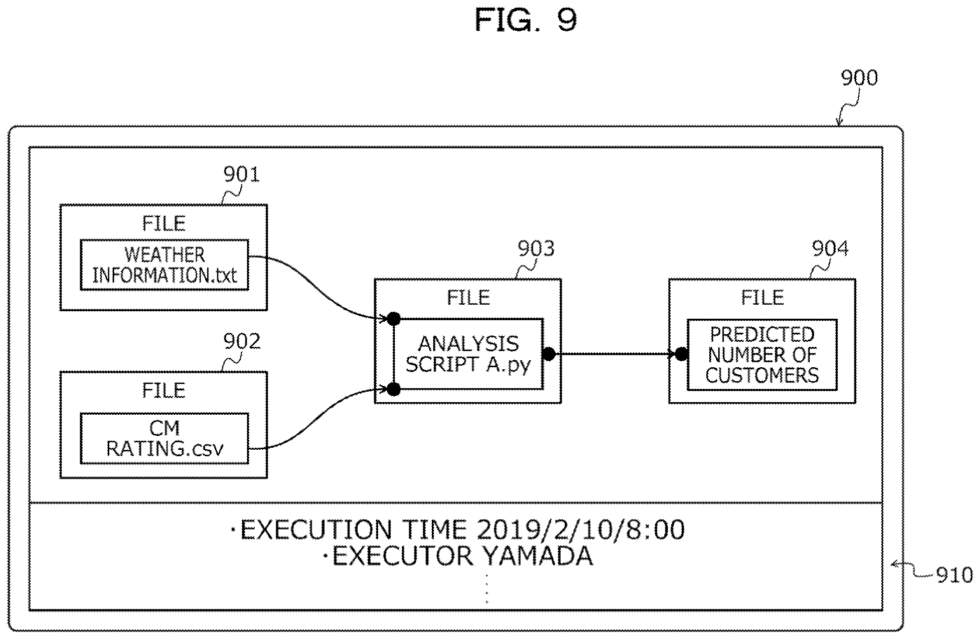

Note that an exemplary process at the time of identifying the input data name (input file name) and the output data name (output file name) from the result of OCR processing and recognizing the screenshot of the window will be described later with reference to FIGS. 8 and 9.

As described above, for example, in a case where the analysis tool is a closed source or not GUI-based software, it is not possible to identify the input data name and the output data name from the descriptive contents of the analysis script or the result of OCR processing and recognizing the image of the window.

In view of the above, it is also permissible if an analysis tool capable of analyzing the contents of the analysis script or a GUI-based analysis tool is registered in a dictionary in advance as software for which data lineage is generated. A specific example of dictionary information in which a tool name for which data lineage is generated is registered will be described,

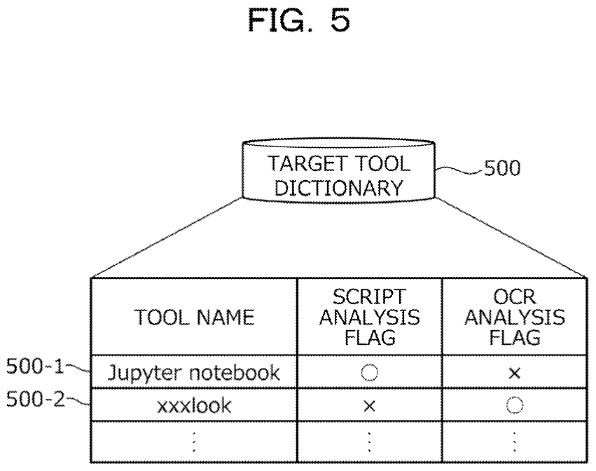

FIG. 5 is an explanatory diagram illustrating a specific example of the dictionary information. In FIG. 5, target tool dictionary 500 is a specific example of the dictionary information in which a tool name for which data lineage is generated is registered. The target tool dictionary 500 has fields for a tool name, a script analysis flag, and an OCR analysis flag, and sets information in each field to store target tool information (e.g., target tool information 500-1 and 500-2) as a record.

Here, the tool name indicates a name of the tool for which data lineage is generated. The script analysis flag is information indicating whether or not the descriptive contents of the analysis script are analyzable. Here, the script analysis flag “◯” indicates that the descriptive contents of the analysis script are analyzable. The script analysis flag “x” indicates that the descriptive contents of the analysis script are not analyzable.

The OCR analysis flag is information indicating whether or not the software is GUI-based. Here, the OCR analysis flag “◯” indicates that the software is GUI-based and that OCR analysis is possible. The OCR analysis flag “x” indicates that the software is not GUI-based and that the OCR analysis is not possible.

The script analysis flag and the OCR analysis flag are examples of information that identifies a type of a tool for which data lineage is generated. For example, using a combination of the script analysis flag and the OCR analysis flag, it is possible to identify a type of the tool for which data lineage is generated, that is, whether it is a tool capable of analyzing the descriptive contents of the analysis script or whether it is a tool capable of performing OCR analysis.

For example, the target tool information 500-1 indicates that the analysis tool with the tool name “Jupyter notebook” is a tool of a type capable of analyzing the descriptive contents of the analysis script but not capable of performing OCR analysis as it is not GUI-based software.

Note that the target tool information may not include the script analysis flag and the OCR analysis flag. For example, the target tool information may be information indicating only the name of the tool for which data lineage is generated. The target tool dictionary 500 is created in advance and stored in the memory 302.

Returning to the description of FIG. 4, the analysis unit 403 may refer to the target tool dictionary 500 illustrated in FIG. 5 to determine whether or not the identified analysis tool is a target tool, for example. Then, in a case where the analysis tool is a target tool, the analysis unit 403 may identify the input data name and the output data name on the basis of the result of analyzing the descriptive contents of the analysis script, or may identify the script name, the input data name, and the output data name on the basis of the result of OCR processing and recognizing the image of the window. On the other hand, in a case where the analysis tool is not a target tool, the analysis unit 403 may not identify the script name, the input data name, and the output data name.

More specifically, for example, in a case where the analysis unit 403 refers to the target tool dictionary 500 and the script analysis flag of the identified analysis tool is “◯”, it may identify the input data name and the output data name on the basis of the result of analyzing the descriptive contents of the analysis script. Furthermore, in a case where the OCR analysis flag of the identified analysis tool is “◯”, the analysis unit 403 may identify the script name, the input data name, and the output data name on the basis of the result of OCR processing and recognizing the image of the window, Furthermore, in a case where the analysis tool name of the identified analysis tool is not registered in the target tool dictionary 500, the analysis unit 403 does not identify the input data name or the like.

The generation unit 404 generates data lineage related to the running analysis script of the analysis tool identified by the identification unit 402 on the basis of the input data name and the output data name identified by the analysis unit 403. Here, the data lineage is historical information indicating how the data has been generated.

Specifically, for example, the generation unit 404 generates data lineage indicating the input file name and the output file name in association with the analysis script name. The analysis script name is identified from, for example, the file name of the analysis script (file currently open) running in the client device 201, or the result of OCR processing and recognizing the screenshot of the window. The data lineage may include, for example, an analysis tool name, a data body of an analysis script, a data body of an input file, and a data body of an output file.

Specific examples of the data lineage will be described later with reference to FIGS. 7 and 9.

The output unit 405 outputs the generated data lineage. An output format of the output unit 405 includes, for example, storage to the memory 302, transmission to another computer by the communication I/F 303, display on the display 304, print output to a printer (not illustrated), or the like.

Specifically, for example, the output unit 405 transmits the generated data lineage to the metadata management server 203. When the metadata management server 203 receives the data lineage from the client device 201, it stores the received data lineage in the metadata repository 220.

Note that the input data name and the output data name may not be identified from either the descriptive contents of the analysis script or the result of OCR processing and recognizing the image of the window. In this case, the generation unit 404 may identify the input data name and output data name included in the information transmitted and received between its own device and the server 202. Then, the generation unit 404 may generate data lineage including the identified analysis tool name and the identified input data name and output data name.

As a result, it becomes possible to generate data lineage capable of identifying the input data and output data corresponding to the analysis tool without knowing the correspondence relationship with the analysis script.

Note that, although the analysis unit 403 identifies the script name, the input data name, and the output data name on the basis of the result of OCR processing and recognizing the image of the window in the case where the descriptive contents of the analysis script are not analyzable in the descriptions above, it is not limited thereto. For example, before analyzing the descriptive contents of the analysis script, the analysis unit 403 may identify the script name, the input data name, and the output data name on the basis of the result of OCR processing and recognizing the image of the window. Then, in a case where the script name, the input data name, and the output data name cannot be identified from the result of OCR processing and recognizing the image of the window, the analysis unit 403 may identify the input data name and the output data name on the basis of the analysis result of the descriptive contents of the analysis script.

### First Exemplary Process when Identifying Input Data Name and Output Data Name

Next, an exemplary process at the time of identifying an input data name and an output data name from descriptive contents of an analysis script will be described with reference to FIGS. 6 and 7.

FIG. 6 is an explanatory diagram illustrating exemplary descriptive contents of an analysis script. In FIG. 6, descriptive contents (source code) of an analysis script 600 are illustrated. The file name of the analysis script 600 is “Analyze_fruit.ipynb”. Note that a part of the descriptive contents of the analysis script 600 is excerpted and displayed in FIG. 6.

In this case, the analysis unit 403 analyzes the descriptive contents of the analysis script 600 to detect a path name from codes 601 to 603, for example, thereby identifying the input file name “testdata.csv”. Furthermore, the analysis unit 403 analyzes the descriptive contents of the analysis script 600 to detect a path name from codes 604 to 606, for example, thereby identifying the output file name “result.csv”.

In this case, the generation unit 404 generates data lineage related to the analysis script 600 on the basis of the identified input file name “testdata.csv” and output file name “result.csv”. Specifically, for example, the generation unit 404 generates data lineage 700 as illustrated in FIG. 7.

FIG. 7 is an explanatory diagram (No. 1) illustrating a specific example of the data lineage. In FIG. 7, the data lineage 700 includes input information 701, script information 702, and output information 703. Here, the input information 701 indicates the input file name “testdata.csv”. The script information 702 indicates the analysis script name “Analyze_fruit.ipynb” of the analysis script 600 (see FIG. 6). The output information 703 indicates the output file name “result.csv”.

According to the data lineage 700, it becomes possible to visualize a dependence relationship between data, and to grasp that the file “result.csv” has been generated as a result of inputting the file “testdata.csv” into the analysis script “Analyze_fruit.ipynb” and performing analysis. Note that the client device 201 may include, in the data lineage 700, the path names of the input file and output file identified from the result of analyzing the descriptive contents of the analysis script 600.

### Second Exemplary Process when Identifying Input Data Name and Output Data Name

Next, an exemplary process at the time of identifying an input data name and an output data name from a result of OCR processing and recognizing a screenshot of a window will be described using FIGS. 8 and 9. Here, a case where an analysis tool is software including a GUI that connects lines to create and execute a calculation flow is assumed.

FIG. 8 is an explanatory diagram (No. 1) illustrating an exemplary screenshot of a window. In FIG. 8, a screenshot 800 is an image of a window identified by a window handle corresponding to a process ID, which includes FIGS. 801 to 804. Here, the FIGS. 801 and 802 are connected to the FIG. 803 by an arrow line, and the FIG. 804 is connected to the FIG. 803 by an arrow line.

Here, the FIGS. 801 and 802 represent the files input to the script from the directions of arrow lines 805 and 806. The FIG. 803 represents a script. The FIG. 804 represents the file output from the script from the direction of an arrow line 807. In this case, the analysis unit 403 identifies the input file name “weather information.txt” and the input file name “CM rating.csv” on the basis of the result of OCR processing and recognizing the screenshot 800.

Furthermore, the analysis unit 403 identifies the analysis script name “analysis script A.py” on the basis of the result of OCR processing and recognizing the screenshot 800. Furthermore, the analysis unit 403 identifies the output file name “predicted number of customers” on the basis of the result of OCR processing and recognizing the screenshot 800.

More specifically, for example, the analysis unit 403 identifies the character string “file” displayed in the window, and identifies, as file names, the respective character strings “weather information.txt”, “CM rating.csv”, and “predicted number of customers” corresponding to the identified character string “file”. Furthermore, the analysis unit 403 identifies the character string “script” displayed in the window, and identifies, as a file name, the character string “analysis script A.py” corresponding to the identified character string “script”.

Furthermore, the input file name and the output file name may be identified from the positional relationship of each file name in the window. For example, the analysis unit 403 identifies, as input file names, the file names “weather information,txt” and “CM rating.csv” located on the left side of the analysis script name “analysis script A.py” in the window. Furthermore, the analysis unit 403 identifies, as an output file name, the file name “predicted number of customers” located on the right side of the analysis script name “analysis script A.py” in the window.

Furthermore, the analysis unit 403 may detect the FIGS. 801 to 804 and the arrow lines 805 to 807 using a technique such as pattern matching. In this case, the analysis unit 403 may determine whether the file name in each of the FIGS. 801, 802, and 804 is an input file name or an output file name from the directions of the arrow lines 805 to 807, for example. Note that “[data analysis software α] customer number prediction” in FIG. 8 corresponds to the analysis tool name.

The generation unit 404 generates data lineage related to the analysis script “analysis script A.py” on the basis of the identified input file name “weather information.txt”, input file name “CM rating.csv”, analysis script name “analysis script A.py”, and output file name “predicted number of customers”. Specifically, for example, the generation unit 404 generates data lineage 900 as illustrated in FIG. 9.

FIG. 9 is an explanatory diagram (No. 2) illustrating a specific example of the data lineage. In FIG. 9, the data lineage 900 includes input information 901 and 902, script information 903, and output information 904. Here, the input information 901 indicates the input file name “weather information.txt”. The input information 902 indicates the input file name “CM rating.csv”. The script information 903 indicates the analysis script name “analysis script A.py”. The output information 904 indicates the output file name “predicted number of customers”.

Furthermore, the data lineage 900 includes execution history information 910. The execution history information 910 indicates the execution time “2019/2/10/8:00” and the executor “Yamada”. The execution time “2019/2/10/8:00” indicates the date and time when the analysis script “analysis script A.py” has been executed. The executor “Yamada” indicates a user (e.g., log-in user) who has execued the analysis script “analysis script. A.py”.

According to the data lineage 900, it becomes possible to visualize a dependence relationship between data, and to grasp that the file “predicted number of customers” has been generated as a result of inputting the file “weather information.txt” and the file “CM rating.csv” into the analysis script “analysis script A.py” and performing analysis. Furthermore, according to the data lineage 900, it becomes possible to grasp the execution time “2019/2/10/8:00” and the executor “Yamada” of the analysis script “analysis script A.py”.

### Third Exemplary Process when Identifying Input Data Name and Output Da Name

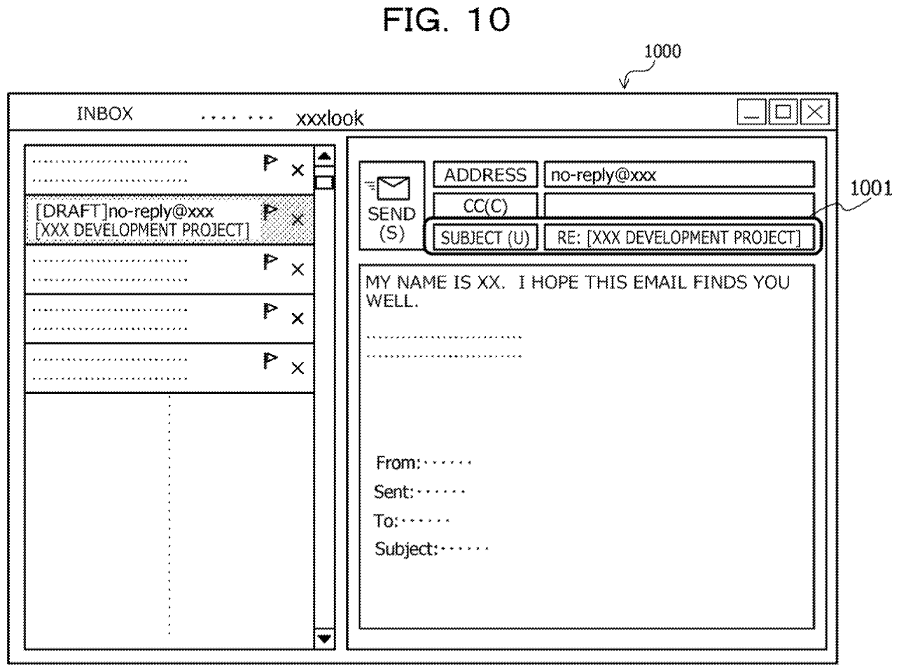

Next, an exemplary process at the time of identifying an input data name and an output data name from a result of OCR processing and recognizing a screenshot of a window will be described using FIG. 10. Here, assuming that an analysis tool is mail software and regarding operation of invoking “reply” as analysis, a case of identifying a received mail to be a source (input) of a reply mail will be described.

FIG. 10 is an explanatory diagram (No. 2) illustrating an exemplary screenshot of a window. In FIG. 10, a screenshot 1000 is an image of a window identified from a window handle corresponding to a process ID, and illustrates an operation screen for creating a reply mail.

In this case, the analysis unit 403 identifies the subject of the reply mail “RE: [xxx development project]” on the basis of the result of OCR processing and recognizing the screenshot 1000 (corresponding to a reference sign 1001 in FIG. 10). Furthermore, the analysis unit 403 identifies the part of the subject of the reply mail “RE: [xxx development project]” excluding “RE:” as a subject “[xxx development project]” of the received mail that is the source of the reply mail.

In this case, the generation unit 404 generates data lineage related to the analysis script “reply” in which the identified subject of the received name “[xxx development project]” and the subject of the reply mail “RE: [xxx development project]” are associated with each other, for example.

At this time, the generation unit 404 may associate the file paths of the received mail and the reply mail with the subjects of the received mail and the reply mail, respectively. The file paths of the respective received mail and reply mail are identified together with the subjects from the information transmitted to and received from the server 202, for example. However, the file path of the reply mail is identified at the timing when the reply mail is actually sent.

As a result, it becomes possible to identify the mail to be the source of the reply mail without modifying the analysis tool (mail software). Note that, although the analysis script “reply” is identified from the operation of invoking the window here, it is not limited thereto. For example, there may be a case where the analysis script name is included in the window name (screen name). Therefore, it is also permissible if the analysis unit 403 identifies the analysis script name by detecting a screen name on the basis of the result of OCR processing and recognizing the screen.

### Information Processing Procedure of Client Device 201

Next, an information processing procedure of the client device 201 will be described. First, an exemplary case where the WebDAV protocol is used as a protocol between the client device 201 and the server 202 will be described.

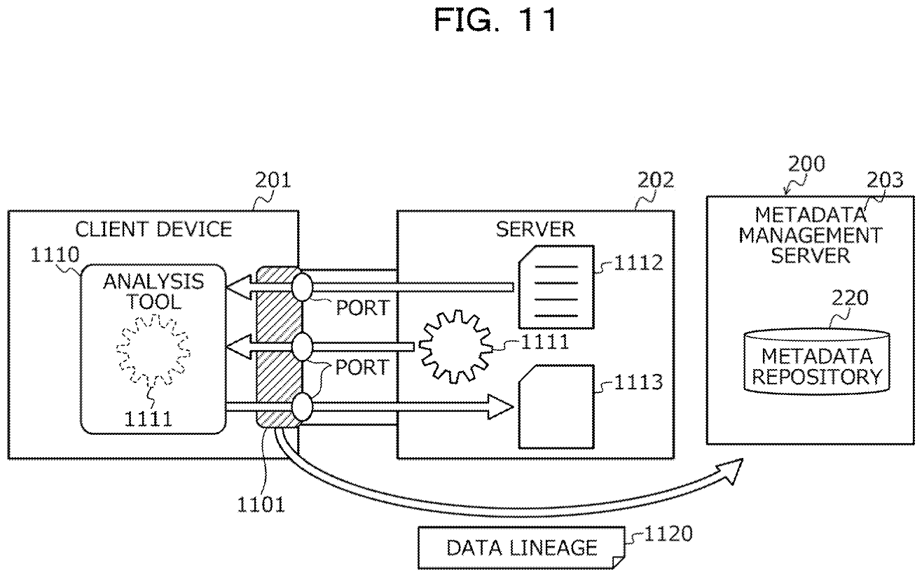

FIG. 11 is an explanatory diagram illustrating a first example of the information processing system 200. In FIG. 11, the client device 201, the server 202, and the metadata management server 203 included in the information processing system 200 are illustrated. In the first example, the client device 201 performs data lineage generation processing using a special tool 1101.

The special tool 1101 is software that runs in the client device 201, and is capable of identifying an input file and an output file by monitoring the protocol between the client device 201 and the server 202.

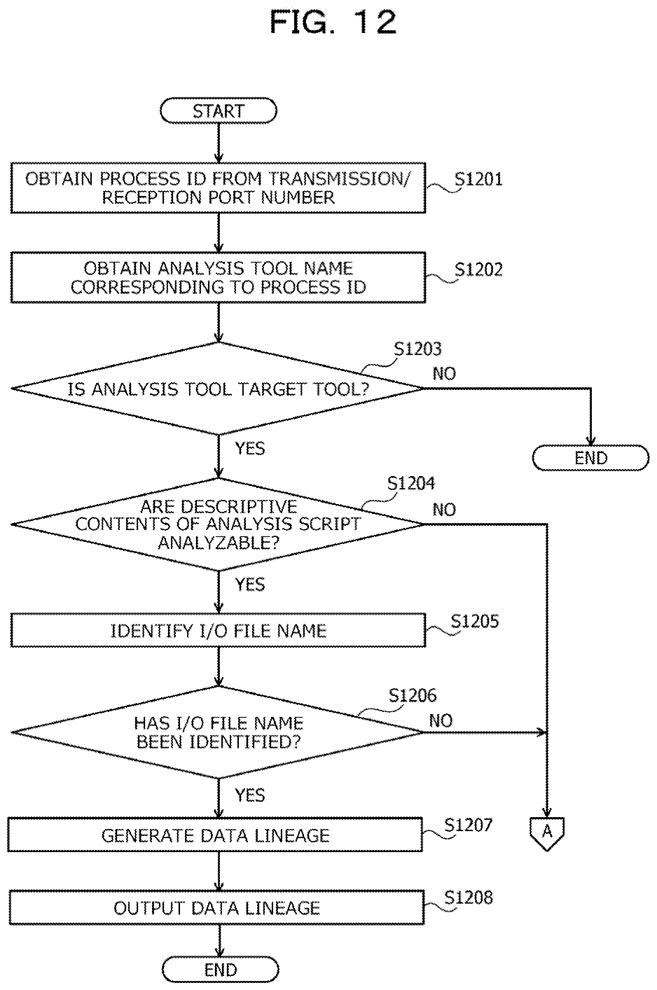

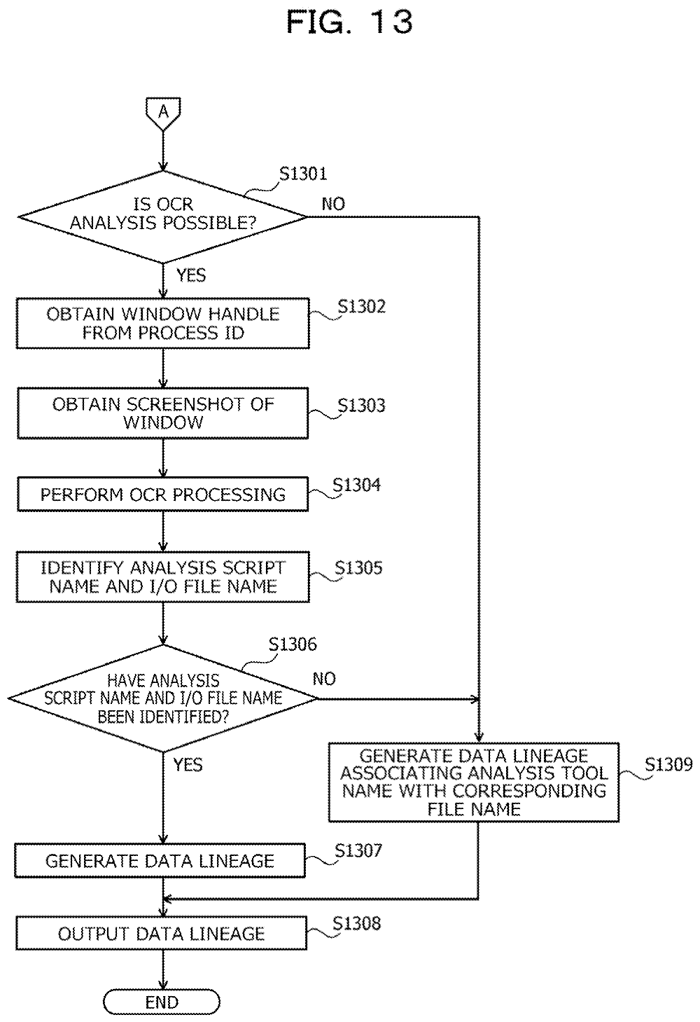

Hereinafter, a procedure of the data lineage generation processing performed by the special tool 1101 will be described using FIGS. 12 and 13.

FIGS. 12 and 13 are flowcharts illustrating an example of a first data lineage generation processing procedure of the client device 201. In the flowchart of FIG. 12, first, the client device 201 uses the special tool 1101 to obtain a process ID from a port number via which information is transmitted to and received from the server 202 using a command such as netstat (step S1201).

Next, the client device 201 uses the special tool 1101 to make an inquiry to the OS using a task manager or the like, thereby obtaining an analysis tool name corresponding to the process ID (step S1202). Then, the client device 201 refers to the target tool dictionary 500 using the special tool 1101 to determine whether or not the analysis tool identified from the obtained analysis tool name is a target tool (step S1203). In the example of FIG. 11, the analysis tool identified from the analysis tool name is an analysis tool 1110.

Here, if it is not the target tool (No in step S1203), the client device 201 terminates the series of processes according to the present flowchart using the special tool 1101. On the other hand, if it is the target tool (Yes in step S1203), the client device 201 refers to the target tool dictionary 500 using the special tool 1101 to determine whether or not the descriptive contents of the analysis script are analyzable (step S1204).

Here, if the descriptive contents of the analysis script are not analyzable (No in step S1204), the client device 201 proceeds to step S1301 illustrated in FIG. 13.

On the other hand, if the descriptive contents of the analysis script are analyzable (Yes in step S1204), the client device 201 identifies, using the special tool 1101, an input file name and an output file name on the basis of the result of analyzing the descriptive contents of the running analysis script of the analysis tool (step S1205).

In the following descriptions, the input file name and the output file name may be referred to as an “I/O file name”. In the example of FIG. 11, the running analysis script of the analysis tool 1110 is an analysis script 1111.

Then, the client device 201 determines whether or not the I/O file name has been identified using the special tool 1101 (step S1206). Here, if the I/O file name has been identified (Yes in step S1206), the client device 201 generates, using the special tool 1101, data lineage related to the running analysis script of the analysis tool on the basis of the identified I/O file name (step S1207),

For example, the data lineage indicates the I/O file name in association with the analysis script name. The analysis script name is identified from, for example, a file name of the file currently being executed (file currently open) in the client device 201.

Then, the client device 201 outputs, using the special tool 1101, the generated data lineage to the metadata management server 203 (step S1208), and terminates the series of processes according to the present flowchart.

Furthermore, if the I/O file name is not identified in step S1206 (No in step S1206), the client device 201 proceeds to step S1301 illustrated in FIG. 13.

In the flowchart of FIG. 13, the client device 201 refers to the target tool dictionary 500 using the special tool 1101 to determine whether or not the analysis tool is capable of performing OCR analysis (step S1301).

Here, if the OCR analysis is not possible (No in step S1301), the client device 201 proceeds to step S1309 using the special tool 1101. On the other hand, if the OCR analysis is possible (Yes in step S1301), the client device 201 makes an inquiry to the OS from the obtained process ID using the special tool 1101, thereby obtaining a window handle corresponding to the process ID (step S1302).

Then, the client device 201 obtains, using the special tool 1101, a screenshot of the window identified from the obtained window handle (step S1303), Next, the client device 201 performs OCR processing on the obtained screenshot using the special tool 1101 (step S1304).

Then, the client device 201 identifies, using the special tool 1101, the analysis script name and the I/O file name on the basis of the result of OCR processing and recognizing the screenshot (step S1305). Next, the client device 201 determines whether or not the analysis script name and the I/O file name have been identified using the special tool 1101 (step S1306),

Here, if the analysis script name and the I/O file name have been identified (Yes in step S1306), the client device 201 generates, using the special tool 1101, data lineage related to the running analysis script of the analysis tool on the basis of the identified analysis script name and I/O file name (step S1307),

Then, the client device 201 outputs, using the special tool 1101, the generated data lineage to the metadata management server 203 (step S1308), and terminates the series of processes according to the present flowchart.

Furthermore, if the analysis script name and the I/O file name are not identified in step S1306 (No in step S1306), the client device 201 generates, using the special tool 1101, data lineage in which the obtained analysis tool name and the corresponding file name are associated with each other (S1309), and proceeds to step S1308.

The corresponding file name is, for example, an I/O file name included in the information transmitted and received between the client device 201 and the server 202 via the transmission/reception port corresponding to the process ID obtained in step S1201.

As a result, it becomes possible to automatically generate data lineage and to register it in the metadata repository 220 without modifying the analysis tool. In the example of FIG. 11, data lineage 1120 indicating a file name of an input file 1112 and a file name of an output file 1113 is automatically generated and registered in the metadata repository 220 in association with the analysis script 1111.

Note that, although it is determined whether or not the descriptive contents of the analysis script are analyzable by referring to the target tool dictionary 500 in step S1204 in the descriptions above, it is not limited thereto. For example, it is also permissible if the client device 201 uses the special tool 1101 to read the analysis script and then determine whether or not the descriptive contents of the analysis script are analyzable.

Next, an exemplary case where the system call protocol is used as a protocol between the client device 201 and the server 202 will be described.

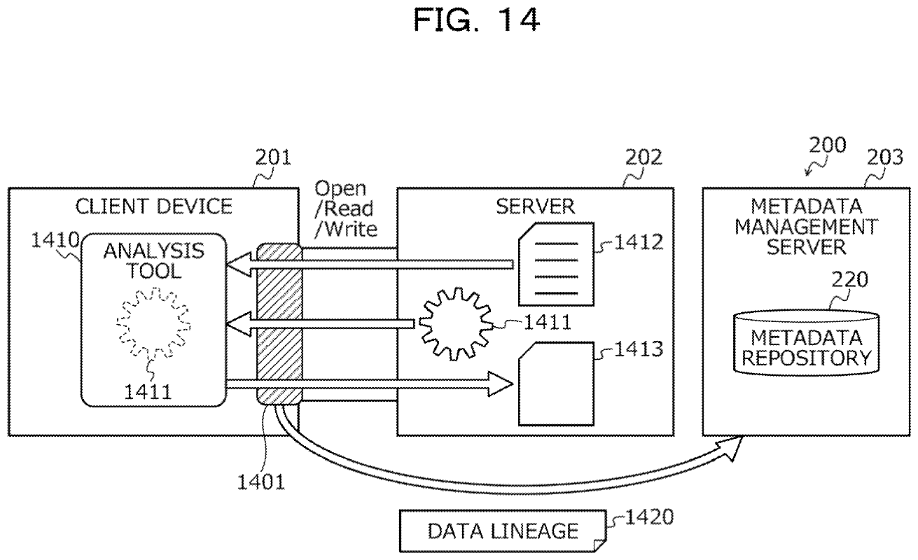

FIG. 14 is an explanatory diagram illustrating a second example of the information processing system 200. In FIG. 14, the client device 201, the server 202, and the metadata management server 203 included in the information processing system 200 are illustrated. In the second example, the client device 201 performs data lineage generation processing using a special file system 1401.

The special file system 1401 is software that runs in the client device 201, and is capable of monitoring a system call between the client device 201 and the server 202. For example, the special file system 1401 may be implemented using a Filesystem in Userspace (FUSE) interface capable of creating a file system with a userland.

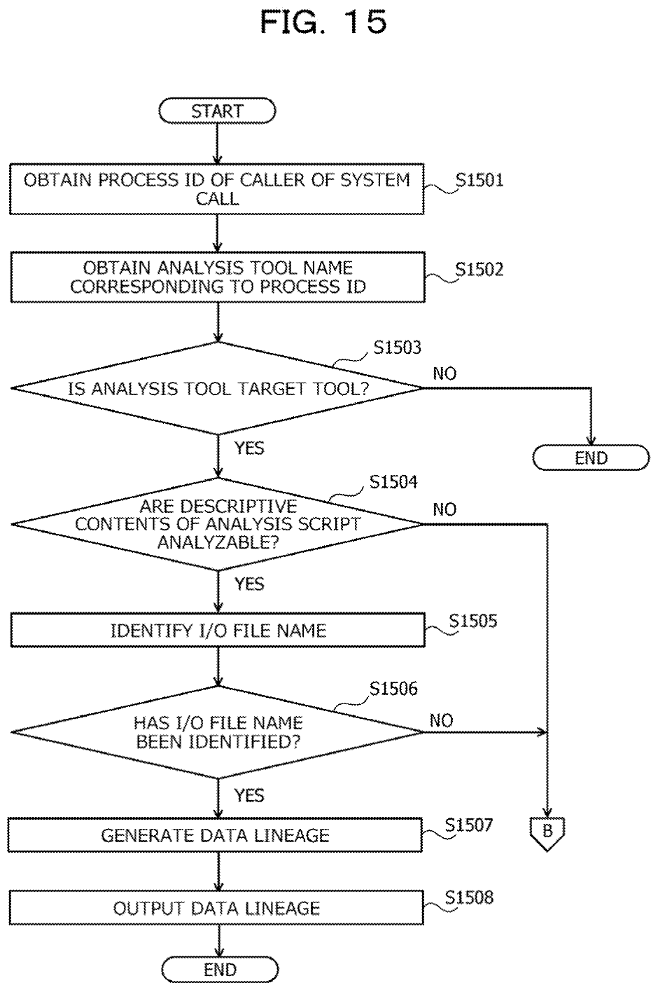

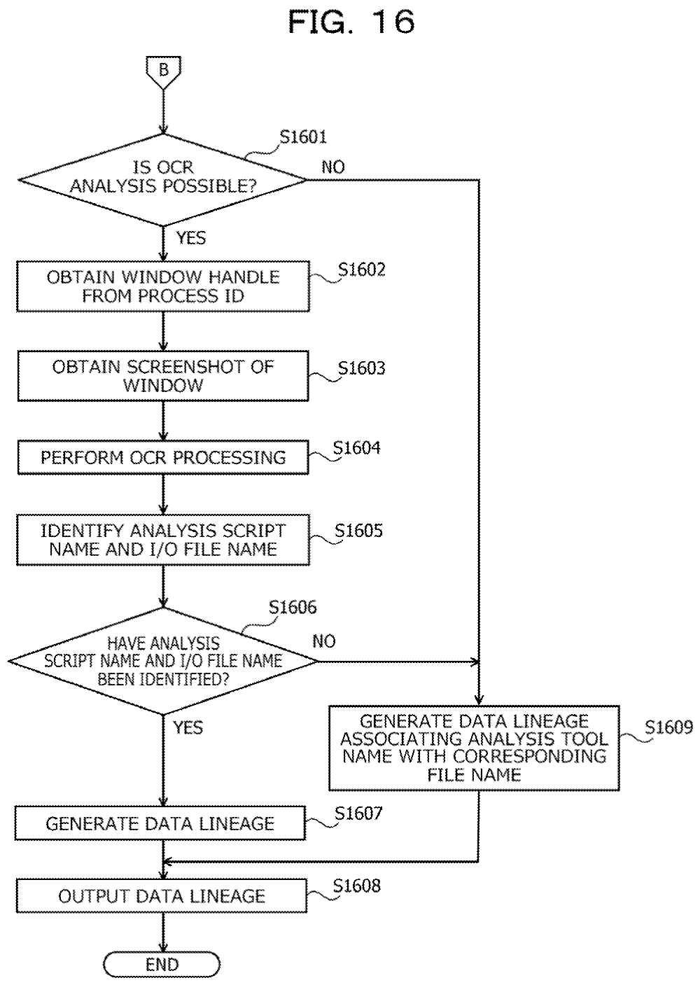

Hereinafter, a procedure of the data lineage generation processing performed by the special file system 1401 will be described using FIGS. 15 and 16.

FIGS. 15 and 16 are flowcharts illustrating an example of a second data lineage generation processing procedure of the client device 201. In the flowchart of FIG. 15, first, the client device 201 obtains a process ID of a caller of a system call using the special file system 1401 (step S1501).

The system call is, for example, a system call of open/read/write. Note that the client device 201 may obtain the process ID that has changed a file using a mechanism of detecting a change of the file using inotify (inode notify), Furthermore, for example, in the case of the FUSE, the client device 201 may obtain the access process (process ID) using fuse_get_context( ) or the like without using the mechanism of detecting a file change.

Next, the client device 201 uses the special file system 1401 to make an inquiry to the OS using a ps command or the like, thereby obtaining an analysis tool name corresponding to the process ID (step S1502). Then, the client device 201 refers to the target tool dictionary 500 using the special file system 1401 to determine whether or not the analysis tool identified from the obtained analysis tool name is a target tool (step S1503). In the example of FIG. 14, the analysis tool identified from the analysis tool name is an analysis tool 1410.

Here, if it is not the target tool (No in step S1503), the client device 201 terminates the series of processes according to the present flowchart using the special file system 1401. On the other hand, if it is the target tool (Yes in step S1503) the client device 201 refers to the target tool dictionary 500 using the special file system 1401 to determine whether or not the descriptive contents of the analysis script are analyzable (step S1504).

Here, if the descriptive contents of the analysis script are not analyzable (No in step S1504), the client device 201 proceeds to step S1601 illustrated in FIG. 16.

On the other hand, if the descriptive contents of the analysis script are analyzable (Yes in step S1504), the client device 201 identifies, using the special file system 1401, an I/O file name on the basis of the result of analyzing the descriptive contents of the running analysis script of the analysis tool (step 51505), In the example of FIG. 14, the running analysis script of the analysis tool 1410 is an analysis script 1411.

Then, the client device 201 determines whether or not the I/O file name has been identified using the special file system 1401 (step S1506). Here, if the I/O file name has been identified (Yes in step S1506), the client device 201 generates, using the special file system 1401, data lineage related to the running analysis script of the analysis tool on the basis of the identified I/O file name (step S1507),

Then, the client device 201 outputs, using the special file system 1401, the generated data lineage to the metadata management server 203 (step S1508), and terminates the series of processes according to the present flowchart.

Furthermore, if the I/O file name is not identified in step S1506 (No in step S1506), the client device 201 proceeds to step S1601 illustrated in FIG. 16.

In the flowchart of FIG. 16, the client device 201 refers to the target tool dictionary 500 using the special file system 1401 to determine whether or not the analysis tool is capable of performing OCR analysis (step S1601).

Here, if the OCR analysis is not possible (No in step S1601), the client device 201 proceeds to step S1609 using the special file system 1401. On the other hand, if the OCR analysis is possible (Yes in step S1601), the client device 201 makes an inquiry to the OS from the obtained process ID using the special file system 1401, thereby obtaining a window handle corresponding to the process ID (step S1602).

Then, the client device 201 obtains, using the special file system 1401, a screenshot of the window identified from the obtained window handle (step S1603). Next, the client device 201 performs OCR processing on the obtained screenshot using the special file system 1401 (step S1604).

Then, the client device 201 identifies, using the special file system 1401, the analysis script name and the I/O file name on the basis of the result of

OCR processing and recognizing the screenshot (step S1605). Next, the client device 201 determines whether or not the analysis script name and the I/O file name have been identified using the special file system 1401 (step S1606).

Here, if the analysis script name and the I/O file name have been identified (Yes in step S1606), the client device 201 generates, using the special file system 1401, data lineage related to the running analysis script of the analysis tool on the basis of the identified analysis script name and I/O file name (step S1607).

Then, the client device 201 outputs, using the special file system 1401, the generated data lineage to the metadata management server 203 (step S1608), and terminates the series of processes according to the present flowchart.

Furthermore, if the analysis script name and the I/O file name are not identified in step S1606 (No in step S1606), the client device 201 generates, using the special file system 1401, data lineage in which the obtained analysis tool name and the corresponding file name are associated with each other (S1609), and proceeds to step S1608.

The corresponding file name is, for example, an I/O file name identified from the inode number included in the information transmitted and received between the server 202 and the caller corresponding to the process ID obtained in step S1501.

As a result, it becomes possible to automatically generate data lineage and to register it in the metadata repository 220 without modifying the analysis tool. In the example of FIG. 14, data lineage 1420 indicating a file name of an input file 1412 and a file name of an output file 1413 is automatically generated and registered in the metadata repository 220 in association with the analysis script 1411.

As described above, according to the client device 201 of the embodiment, it becomes possible to obtain a process ID being executed in the device itself on the basis of information transmitted and received between the device itself and the server 202 using a predetermined protocol, and to identify an analysis tool corresponding to the process on the basis of the obtained process ID. Furthermore, according to the client device 201, it becomes possible to analyze descriptive contents of the running analysis script of the identified analysis tool, to identify an input data name and an output data name on the basis of the analysis result, and to generate data lineage related to the analysis script on the basis of the identified input data name and output data name. Specifically, for example, the client device 201 is capable of generating data lineage indicating the input data name and the output data name in association with the script name. The script name is identified from, for example, a file name of the analysis script (file currently open) currently running in the client device 201.

As a result, it becomes possible to automatically generate data lineage in which an analysis script and input/output data are associated with each other without modifying an analysis tool. Therefore, for example, even in the case of using an analysis tool not supporting specific metadata management software, it is possible to generate data lineage by which it is possible to grasp what kind of analysis has been performed on which data and which data has been generated.

Furthermore, according to the client device 201, in a case where the descriptive contents of the analysis script are not analyzable, it is possible to obtain a window handle corresponding to the obtained process ID, and to identify an analysis script name, an input data name, and an output data name on the basis of the result of OCR processing and recognizing the image (screenshot) of the window identified from the obtained window handle. In addition, according to the client device 201, it is possible to generate data lineage on the basis of the identified script name, input data name, and output data name.

As a result, in a case where the contents of the analysis script are not analyzable, it is possible to perform OCR processing on the screenshot of the window of the GUI, to identify the analysis script name, the input data name, and the output data name displayed on the window, and to generate data lineage in which the analysis script and the input/output data are associated with each other.

Furthermore, according to the client device 201, in a case where the analysis script name, the input data name, and the output data name are not identified, it is possible to generate data lineage related to the analysis tool on the basis of the file name included in the information transmitted and received between the device itself and another device using a predetermined protocol.

As a result, in a case where the OCR analysis is not possible or various file names cannot be identified even after the OCR analysis, it is possible to generate data lineage capable of identifying input data and output data corresponding to the analysis tool without knowing the correspondence relationship with the analysis script.

Furthermore, according to the client device 201, it is possible to determine whether or not the identified analysis tool is a target tool by referring to the target tool dictionary 500. In addition, according to the client device 201, in a case where the analysis tool is a target tool, it is possible to identify the input data name and the output data name on the basis of the result of analyzing the descriptive contents of the analysis script.

As a result, it becomes possible to prevent data lineage from being generated for software that does not need to generate data lineage. Furthermore, it becomes possible to prevent unnecessary processing, such as analysis of descriptive contents of a script and OCR processing of a window, from being performed on software of a type not capable of generating data lineage.

Furthermore, according to the client device 201, in a case where the analysis tool is a target tool by referring to the target tool dictionary 500, it is possible to identify the input data name and the output data name on the basis of the result of analyzing the descriptive contents of the analysis script, or to identify the script name, the input data name, and the output data name on the basis of the result of OCR processing and recognizing the image of the window according to the type of the analysis tool.

As a result, in a case where the analysis tool is software (e.g., open source) of a type capable of analyzing contents of an analysis script, it is possible to identify an input data name and an output data name by analyzing the descriptive contents of the analysis script. For example, it becomes possible to prevent unnecessary processing, such as attempting to analyze contents of an analysis script despite the fact that the analysis tool is software (e.g., closed source) of a type not capable of analyzing the contents of the analysis script. Furthermore, in a case where the analysis tool is software of a type having a GUI for executing an analysis script, it becomes possible to identify a script name, an input data name, and an output data name by performing OCR processing on the image of the window. For example, it becomes possible to prevent unnecessary processing, such as attempting to obtain an image (screenshot) of a window or to perform OCR processing on the image despite the fact that the analysis tool is software of a type not having a GUI for executing an analysis script.

Furthermore, according to the client device 201, it is possible to output the generated data lineage. For example, the client device 201 is capable of transmitting the generated data lineage to the metadata management server 203.

As a result, it is possible to register the data lineage generated by the client device 201 in the metadata repository 220 of the metadata management server 203.

Furthermore, according to the client device 201, in the case of using a WebDAV protocol, it is possible to obtain a process ID from a port number via which information is transmitted to and received from the server 202 using a command such as netstat. Furthermore, according to the client device 201, in the case of using a system call protocol, it is possible to obtain a process ID of a caller of a system call transmitted to and received from the server 202.

As a result, it is possible to identify a process ID of the process being executed in the client device 201 by monitoring the protocol between the client device 201 and the server 202.

With the arrangements described above, according to the information processing system 200 and the client device 201 of the embodiment, it becomes possible to automatically generate data lineage and to register it in the metadata repository 220 without modifying the analysis tool. As a result, it becomes possible to grasp what kind of analysis has been performed on which data and which data has been generated, thereby promoting data utilization.

Note that the information processing method described in the present embodiment may be implemented by executing a prepared program on a computer such as a personal computer or a workstation. This information processing program is recorded on a computer-readable recording medium such as a hard disk, flexible disk, compact disk read only memory (CD-ROM), magneto-optical disk (MO), digital versatile disc (DVD), or USB memory, and is read from the recording medium to be executed by the computer. Furthermore, this information processing program may be distributed through a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory and configured to:
obtain an identifier of a process being executed in the information processing device;
identify a data processing tool corresponding to the process on the basis of the identifier of the process;
analyze descriptive contents of a running script of the identified data processing tool to identify an input data name and an output data name on the basis of an analysis result; and
generate data lineage related to the scripton the. basis of the input data name and the identified output data name.

2. The information processing device according to claim 1, wherein
the processor
obtains, in a case where the descriptive contents of the script are not analyzable, a window handle corresponding to the identifier of the process,
identifies a script name, an input data name, and an output data name on the basis of a result of recognizing information in the window identified from the obtained window handle, and
generates the data lineage on the basis of the script name, the input data name, and the identified output data name.

3. The information processing device according to claim 2, wherein
the processor
refers to dictionary information in which a tool for which the data lineage is to be generated is registered, and determines whether or not the identified data processing tool is a target tool; and
analyzes, in a case where the data processing tool is the target tool, the descriptive contents of the script to identify the input data name and the output data name on the basis of the analysis result.

4. The information processing device according to claim 3, wherein
the dictionary information includes information that identifies a type of the tool for which the data lineage is to be generated, and
the processor identifies,
in a case where the data processing tool is the target tool by referring to the dictionary information, the input data name and the output data name on the basis of a result of analyzing the descriptive contents of the script according to the type of the data processing tool, or identifies the script name, the input data name, and the output data name on the basis of the result of recognizing the information in the window.

5. The information processing device according to claim 4, wherein the processor outputs the data lineage.

6. The information processing device according to claim 5, wherein the data lineage is information indicating the input data name and the output data name in association with the script name of the script.

7. The information processing device according to claim 6, wherein the processor obtains the identifier of the process being executed in the information processing device on the basis of information transmitted and received between the information processing device and another device using a predetermined protocol.

8. The information processing device according to claim 7, wherein the processor obtains the identifier of the process being executed in the information processing device from a port number via which the information is transmitted to and received from the another device.

9. The information processing device according to claim 7, wherein the processor obtains an identifier of a process of a caller of a system call transmitted to and received from the another device.

10. The information processing device according to claim 7, wherein the processor generates, in a case where the script name, the input data name, and the output data name are not identified, data lineage related to the data processing tool on the basis of a data name included in the information transmitted and received between the information processing device and the another device using the protocol.

11. An information processing system comprising:
an information processing device configured to:
obtain an identifier of a process being executed in the information processing device;
identify a data processing tool corresponding to the process on the basis of the identifier of the process;
analyze descriptive contents of a running script of the identified data processing tool i to identify an input data name and an output data name on the basis of an analysis result; and
generate data lineage related to the script on the bass of he input data name and the identified output data name.

12. The information processing system according to claim 11, wherein
the information processing device
obtains, in a case where the descriptive contents of the script are not analyzable, a window handle corresponding to the identifier of the process,
identifies a script name, an input data name, and an output data name on the basis of a result of recognizing information in the window identified from the obtained window handle, and
generates the data lineage on the basis of the script name, the input data name, and the identified output data name.

13. A non-transitory computer-readable recording medium storing an information processing program causing a computer to execute processing of:
obtaining an identifier of a process being executed in the information processing device;
identifying a data processing tool corresponding to the process on the basis of the identifier of the process;
analyzing descriptive contents of a running script of the identified data processing tool to identify an input data name and an output data name on the basis of an analysis result; and
generating data lineage related to the script on the psis of the input data name and the identified output data name.

14. The non-transitory computer-readable recording medium according to claim 13, further comprising:
obtaining, in a case where the descriptive contents of the script are not analyzable, a window handle corresponding to the identifier of the process,
identifying a script name, an input data name, and an output data name on the basis of a result of recognizing information in the window identified from the obtained window handle, and
generating the data lineage on the basis of the script name, the input data name, and the identified output data name.
